(19) United States
(12) Patent Application Publication
(10) Pub. No.: US 2012/0331526 A1
(43) Pub. Date: Dec. 27, 2012

(54) MULTI-LEVEL, HASH-BASED DEVICE INTEGRITY CHECKS

(75) Inventors: Rodney D. Caudle, Kansas City, MO (US); Ryan D. Walters, Falls Church, VA (US); Timothy L. Decamp, Vienna, VA (US)

(73) Assignee: TerraWi, Inc., Falls Church, VA (US)

(21) Appl. No.: 13/166,219

(22) Filed: Jun. 22, 2011

(51) Int. Cl. G06F 21/20

(52) U.S. Cl. 726/4; 726/7

(57) ABSTRACT

In some embodiments, a non-transitory processor-readable medium stores code representing instructions configured to cause a processor to receive, from a mobile device, a first signal including a hash value. The hash value can be based at least in part on a hardware component of the mobile device and a software module stored at the mobile device. The code can further represent instructions configured to cause the processor to send, to the mobile device, a second signal when the hash value matches a stored hash value associated with the mobile device, the second signal configured to grant, to the mobile device, access to a network.

### BACKGROUND

Some embodiments described herein relate generally to hash-based validation of device identity and/or configuration, and more particularly to methods and apparatus for multi-level, hash-based validation of identity, hardware configuration, software configuration and/or software permission configuration of a mobile device.

Many known network gatekeeping methods seek to prevent unauthorized network access by performing one or more authentication routines as part of the mobile client login process. Such methods often require a user to provide one or more access credentials, such as a username, password or other credential that authenticates the user's identity. While such methods may successfully verify the identity of an individual user, they generally fail to determine whether the user's mobile device includes a hardware and/or software configuration that qualifies the mobile device to access the network's resources. Thus, a need exists for methods and apparatus that accurately determine whether a requesting mobile device is authorized to access a network based on an identity, hardware configuration, software configuration and/or software permission configuration of the mobile device.

### SUMMARY

In some embodiments, a non-transitory processor-readable medium stores code representing instructions configured to cause a processor to receive, from a mobile device, a first signal including a hash value. The hash value can be based at least in part on a hardware component of the mobile device and a software module stored at the mobile device. The code can further represent instructions configured to cause the processor to send, to the mobile device, a second signal when the hash value matches a stored hash value associated with the mobile device, the second signal configured to grant, to the mobile device, access to a network.

### BRIEF DESCRIPTION OF THE FIGURES

FIG. 1 is a schematic block diagram that illustrates a multi-level, hash-based device validation system, according to an embodiment.

FIG. 2 is a schematic diagram that illustrates a mobile device having multiple hardware components and storing multiple software modules, including a configuration hash module, according to another embodiment.

FIG. 3 is a schematic diagram that illustrates an access server storing an authentication module and a validation module, according to another embodiment.

FIG. 4 is a schematic block diagram that illustrates a mobile device validation process performed at a hash-based device validation system, according to another embodiment.

FIG. 5 is a flow chart describing a method of validating a mobile device for access to a protected resource, according to another embodiment.

FIG. 6 is a diagram that illustrates a method of calculating a device configuration hash value, according to another embodiment.

### DETAILED DESCRIPTION

In some embodiments, a mobile device can request access to a protected network resource included in a private network. The mobile device can be, for example, a cellular telephone (e.g., a smartphone), a tablet computing device, a laptop, notebook, or netbook computer, etc. In some embodiments, the mobile device can include the request in one or more signals sent to an access server of the private network via a public wireless network (e.g., a commercial cellular telephone network, a commercial wireless broadband network, etc.). The access server can be and/or include one or more hardware modules and/or software modules (executing in hardware) configured to regulate access of client devices to the private network. The private network can be a local area network (LAN), wide area network (WAN), intranet, extranet, etc. associated with a given entity or entities. The private network can optionally include one or more databases, application servers, routers, switches, and/or the like.

In response to the access request received from the mobile device, the access server can (1) determine whether a user of the mobile device is a valid user of the private network, and/or (2) determine whether the mobile device includes a valid hardware and/or software configuration compatible and/or consistent with one or more configuration requirements associated with the private network. For example, the access server can query the mobile device for, and receive from the mobile device, one or more user authentication credentials. Based at least in part on the received authentication credentials, the access server can determine whether the user of the mobile device is a valid/recognized user of the private network.

To determine whether the mobile device includes a valid hardware and/or software configuration compatible with one or more configuration requirements associated with the private network, the access server can perform an “integrity check” of the mobile device. In some embodiments, the mobile device can first determine whether a current configuration hash value associated with the mobile device is equivalent to a previously-calculated and stored configuration hash value associated with the mobile device. For example, the access server can receive, from the mobile device, a signal including a current configuration hash value for the mobile device that it can compare to the previously-calculated, stored configuration hash value for that mobile device. If the access server determines that the two configuration hash values are equal and/or equivalent, the configuration hash value can determine that the current hardware and/or software configuration of the mobile device is valid, and can accordingly send a signal to the mobile device granting access to the protected resource and/or the private network.

Alternatively or additionally, in some embodiments, the access server can perform a full integrity check of the requesting mobile device. To do so, the access server can send a signal requesting identifier information of one or more hardware components, software modules and/or software features/permissions/capabilities of the mobile device. Upon receipt of the requested information from the mobile device, the access server can determine whether each hardware component, software module and/or software feature/permission/capability of the mobile device meets predefined constraints and/or requirements associated with the private network. To do so, the access server can compare each identifier with one or more relevant lists or records of permitted/valid hardware component types, software modules and/or software features, permissions and/or capabilities. In some embodiments, the mobile device can compare each identifier with one or more lists or records of prohibited/invalid hardware component types, software modules and/or software features, permissions and/or capabilities.

If the access server determines that any of the above elements of the mobile device is included in a list of prohibited/invalid device elements, the access server can determine that the mobile device has an invalid hardware and/or software configuration. Based at least in part on this determination, the access server can send a signal to the mobile device indicating that the mobile device has been denied access to the protected resource and/or private network. Alternatively, if the access server determines that no elements of the mobile device are prohibited or invalid, the access server can send a signal to the mobile device indicating that the mobile device has been granted access to the protected resource and/or the private network. The access server can then, accordingly, send one or more subsequent signals to the mobile device such that the mobile device obtains access to and/or commences interaction with the protected resource and/or the private network.

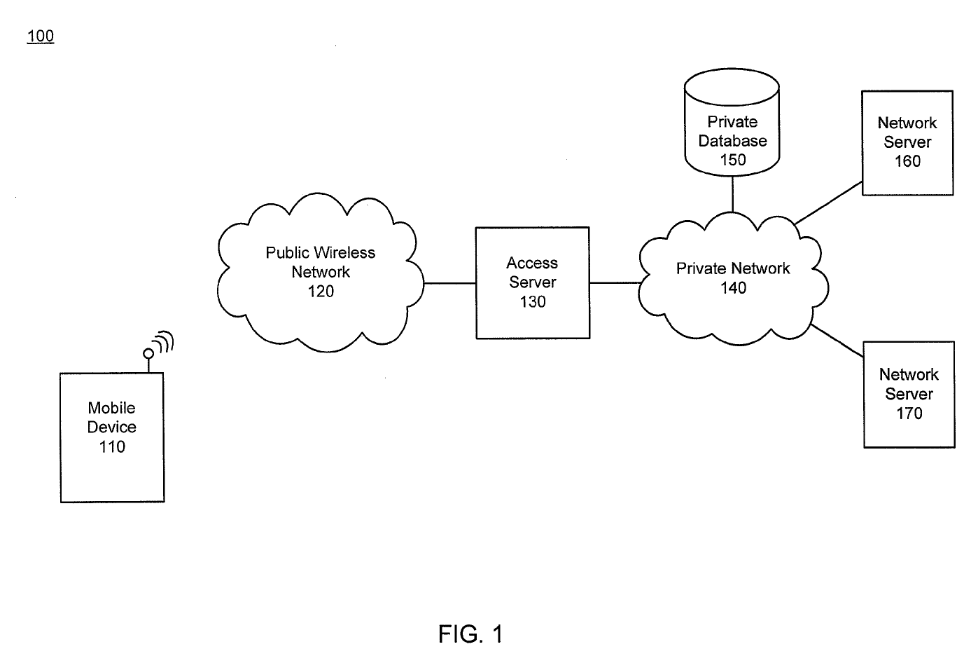

FIG. 1 is a schematic diagram that illustrates a multi-level, hash-based device validation system, according to an embodiment. More specifically, FIG. 1 illustrates a device validation system 100 that includes a mobile device 110 operatively coupled to an access server 130 via a public wireless network 120. The access server 130 is in communication with a private network 140, which includes and/or is physically and/or operatively coupled to each of a private database 150, a network server 160 and a network server 170.

The mobile device 110 can be any valid mobile computing device. For example, the mobile device 110 can be a mobile telephone (e.g., a cellular telephone, a smartphone, a satellite telephone) and/or other mobile computing device (e.g., a tablet computing device, a personal digital assistant (PDA), etc.). Although not shown in FIG. 1, the mobile device 110 can have or include one or more antennae and/or network cards (e.g., cellular network communication cards, wireless Ethernet cards, etc.) configured to enable the mobile device 110 to exchange information via one or more wireless networks, such as the public wireless network 120. In some embodiments, the mobile device 110 can include, be operatively coupled to and/or be physically coupled to one or more input devices and/or peripheral devices (e.g., a display, a touchscreen, a keypad or keyboard, a pointer device, a stylus, etc.). Although not shown in FIG. 1, in some embodiments, multiple mobile devices, similar to the mobile device 110, can be operatively coupled (e.g., wirelessly coupled) to the public wireless network 120, and/or to one or more elements of the private network 140 (via the public wireless network 120).

The public wireless network 120 can be any public wireless network configured to allow two or more client, server, peripheral or other devices to exchange data wirelessly. For example, the public wireless network 120 can be a cellular telephone and/or data network (e.g., a wireless broadband network) configured to transmit data according to any of the Global System for Mobile (GSM), GSM/General Packet Radio Service (GPRS), GSM Enhanced Data Rates for GSM Evolution (EDGE), Code Division Multiple Access (CDMA), CDMA2000, WCDMA (Wideband CDMA), Time Division Multiple Access (TDMA), IEEE 802.11x (“Wi-Fi”), 802.16x (“WiMax”), and/or Long Term Evolution (LTE) standards, and/or one or more other similar standards or protocols. In some embodiments, the public wireless network 120 can be associated with one or more public or private wireless network providers or administrators. For example, the public wireless network 120 can be associated with, constructed, configured and/or administered by a consumer cellular telephone entity, a wireless data provider (e.g., a wireless broadband provider), an Internet Service Provider (ISP), a governmental agency, etc.

The access server 130 can be any combination of hardware and/or software (executing in hardware) configured to (1) authenticate a user of the mobile device 110, and (2) validate the configuration of the mobile device 110. Said differently, the access server 130 can be any device configured to receive requests to access the private network 140 and grant such access only to authenticated users using validated mobile devices. In some embodiments, the access server 130 can be configured to grant full access to the private network 140 to authenticated users, and to grant limited access to the private network 140 to unauthenticated users and/or other individuals. In some embodiments, the access server 130 can include one or more network cards (not shown in FIG. 1), such as one or more Ethernet, Fibre Channel, or other network cards configured to exchange packets, cells and/or other data package formats. As shown in FIG. 1, the access server 130 can be physically and/or operatively coupled to each of the public wireless network 120 and the private network 140. In some embodiments, the access server 130 can be situated in a same physical location as one or more elements of the private network 140 (e.g., the private database 150, the network server 160, the network server 170). The access server 130 can also optionally be included in a same physical device or chassis as one or more of the private database 150, the network server 160 and/or the network server 170. Although not shown in FIG. 1, in some embodiments, the functionality of access server 130 can be distributed across two or more physical devices, each physically and/or operatively coupled to the private network 140 and the public wireless network 120.

The private network 140 can be any private network configured to allow two or more client and/or server devices to exchange information to a restricted set of devices and/or individuals. For example, the private network 140 can be a local area network (LAN), a wide area network (WAN), an intranet, an extranet, or other private network type. In some embodiments, the private network 140 can include and/or be physically coupled and/or operatively coupled to one or more client, server and/or networking devices (e.g., client desktop computers, client mobile devices, database servers, rack-mounted servers, storage area network (SAN) devices, network switches, network routers, etc.) (not shown in FIG. 1). As shown in FIG. 1, the private network 140 can include or be operatively coupled to the access server 130, the private database 150, the network server 160, and the network server 170. Although not shown in FIG. 1, access to the private network 140 can be restricted based on one or more rules and/or requirements. More specifically, access to the private network 140 can be managed by the access server 130, which can administer one or more authentication, validation and/or other policies designed to restrict access to the private network 140.

The private database 150 can be any device (e.g., a network server) storing one or more databases. As shown in FIG. 1, the private database 150 can be operatively coupled to the access server 130, the network server 160 and the network server 170 via the private network 140. Although not shown in FIG. 1, in some embodiments, the private network 140 can be coupled to and/or include multiple private databases similar to the private database 150. In some embodiments, the private database 150 can include one or more relational databases including one or more relational database tables. For example, the private database 150 can include one or more Oracle, Microsoft SQL Server, MySQL, PostgreSQL, Informix and/or other databases storing contact, messaging, document, multimedia, permissions, credentials, access history, and/or other data associated with a user of the mobile device 110 and/or the mobile device 110 itself. Although not shown in FIG. 1, the private database 150 can store information accessible only to devices authorized and validated for interaction with the private network 140. In some embodiments, the private database 150 can store some information accessible only to authenticated users, and can store other information accessible to unauthenticated users and/or other individuals. In some embodiments, access to one or more databases, database tables, database columns and/or database rows of the private database 150 can be restricted, by the access server 130, to users and/or devices conforming to a predetermined set of requirements and/or having a predetermined configuration and/or set of credentials.

The network server 160 and the network server 170 can be any combination of hardware and/or software configured to provide resources to client devices accessing the private network 140. As shown in FIG. 1, the network server 160 and the network server 170 can be operatively coupled to the private database 150, to the access server 130, and to one another via the private network 140. Although not shown in FIG. 1, in some embodiments, the private network 140 can include fewer or more than two network servers similar to the network servers 160 and 170. Each of the network servers 160 and 170 can optionally be configured to store and execute one or more network applications or services (e.g., cloud-based applications, server-side applications, etc.) for access by the mobile device 110. For example, the network server 160 can execute an e-mail, productivity (e.g., contacts, calendar, word-processing), or other application for access by the mobile device 110 via the public wireless network 120 and the private network 140. Alternatively or additionally, the network server 170 can host an imaging, image-editing, data management, or other cloud-based application or applications.

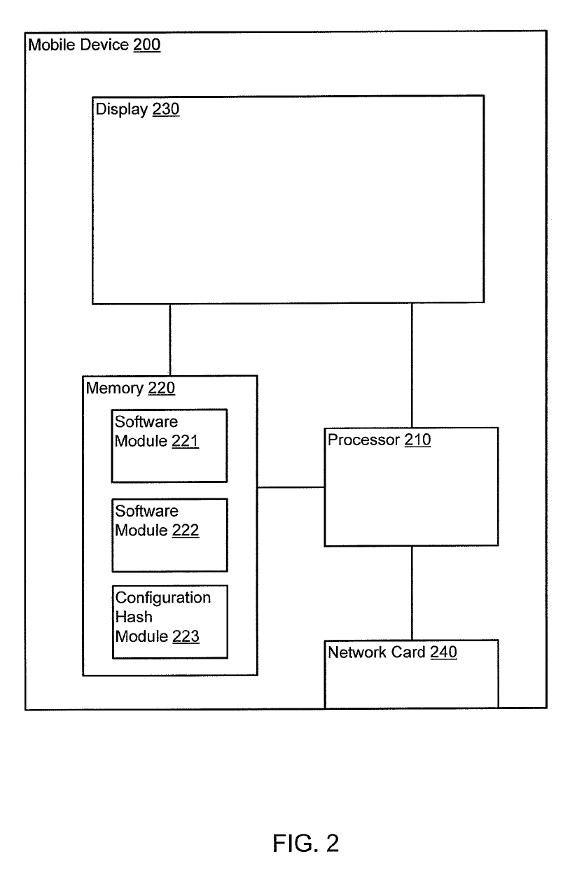

FIG. 2 is a schematic diagram that illustrates a mobile device having multiple hardware components and storing multiple software modules, including a configuration hash module, according to another embodiment. More specifically, FIG. 2 is a system block diagram of a mobile device 200, similar to the mobile devices 110 described in connection with FIG. 1 above. The mobile device 200 includes a processor 210 operatively coupled to a memory 220, to a display 230 and to a network card 240. As shown in FIG. 2, the memory 220 includes three software modules: a software module 221, a software module 222, and a configuration hash module 223. In some embodiments, the mobile device 200 can include additional hardware modules and/or software modules (executing in hardware or stored in memory) not shown in FIG. 2. For example, the mobile device 200 can include one or more input devices and/or peripherals, one or more data input ports, etc.

The processor 210 can be any processor (e.g., a central processing unit (CPU), an application-specific integrated circuit (ASIC), and/or a field programmable gate array (FPGA)) configured to execute one or more instructions received from, for example, the memory 220. In some embodiments, the processor 210 can be a mobile device microprocessor specifically designed to execute on or within a mobile device (e.g., Reduced Instruction Set computing (RISC) processor). As shown in FIG. 2, the processor 210 can be in communication with any of the memory 220, the display 230 and the network card 240. In some embodiments, the processor 210 can accordingly send information (e.g., data, instructions and/or network data packets) to and/or receive information from any of the memory 220, the display 230 and the network card 240.

The memory 220 can be any memory (e.g., a RAM, a ROM, a hard disk drive, an optical drive, other removable media) configured to store information (e.g., a mobile operating system, one or more software applications, media content, text content, contact information, etc.). As shown in FIG. 2, the memory 220 can include a software module 221, a software module 222 and a configuration hash module 223. In some embodiments, the memory 220 can include instructions (e.g., code) sufficient to define and/or execute the software module 221, the software module 222 and the configuration hash module 223. Each of the software modules 221 and 222 can be any installed software program (e.g., a software module, package, class, driver, applet, etc.). Either or both of the software module 221 and the software module 222 can be a mobile device application (“app”), such as a messaging, contacts, calendar, productivity, multimedia, navigation, shopping, or other type of app. In some instances, either or both of the software module 221 and the software module 222 can be or can include malicious software code and/or functionality (e.g., a virus, a worm, or a malware, adware, and/or spyware module), and/or non-malicious software code and/or functionality.

The configuration hash module 223 can optionally be a software module configured to calculate, receive and/or compare one or more configuration hash values associated with the mobile device 200. As shown in FIG. 2, the configuration hash module 223 can be included in the memory 220, and thus can be accessed by the processor 210. In some embodiments, the configuration hash module 223 can calculate a configuration hash value associated with the mobile device 200. For example, the configuration hash module 223 can determine (e.g., obtain, look-up, retrieve) one or more hardware component identifiers (e.g., unique hardware component identifiers, such as serial numbers), software module identifiers and/or software permission identifiers associated with hardware components, software modules and/or software permission settings/values associated with the mobile device 200. In some embodiments, the configuration hash module 223 can determine (e.g., obtain, look-up, retrieve) a device identifier associated with the mobile device 200 itself, such as a serial number or unique part number.

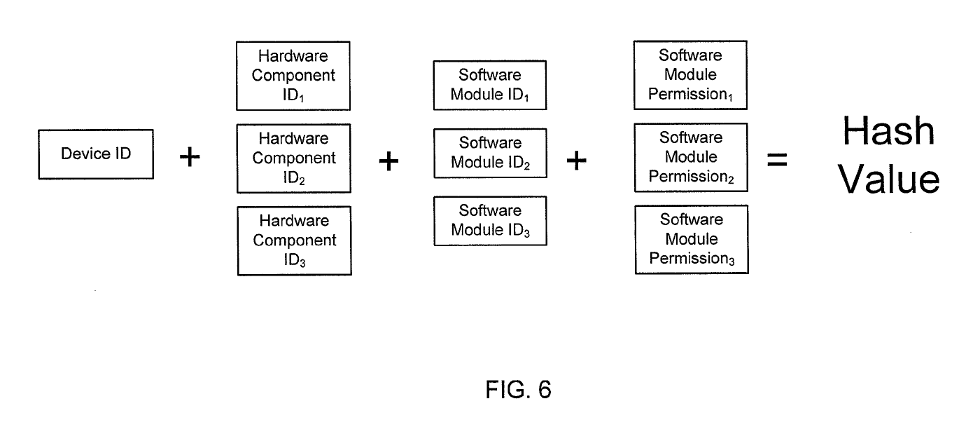

To receive, obtain and/or determine the above-described hardware and/or software information (“device configuration information”), the configuration hash module 223 can access a predetermined location in the memory 220 associated with such information, and/or access one or more device, system, and/or software settings stored at a storage memory included in the mobile device 200 (e.g., a hard disk or optical disc included in the mobile device 200 (not shown in FIG. 2)). Based at least in part on the received/determined device configuration information associated with the mobile device 200, the configuration hash module 223 can determine (e.g., calculate) a configuration hash value for the mobile device 200. In some embodiments, the configuration hash module 223 can add, multiply, divide and/or perform one or more other mathematical, logical or other operations on the device configuration information associated with the mobile device 200 to define the configuration hash value for the mobile device 200. As described in connection with FIG. 6 below, in some embodiments, the configuration hash module 223 can perform a weighted sum or other combination of the character values of the various identifiers included in the device configuration information.

Having defined this configuration hash value for the mobile device 200, the configuration hash module 223 can next compare the defined configuration hash value to a previous and/or stored configuration hash value associated with the mobile device 200 (i.e., a configuration hash value defined based on a previous calculation associated with a configuration of the mobile device 200 at a previous time). By so doing, the configuration hash module 223 can determine whether the configuration of the mobile device 200 has changed in any way since the previous calculation. In some instances, based at least in part on this determination, the configuration hash module 223 can indicate, (e.g., to another software module and/or network access device) that the configuration of the mobile device 200 has changed (and thus, e.g., that a new device configuration/integrity check should be performed by the mobile device 200 and/or one or more other devices or modules).

In some embodiments, any of the software modules 221-222 and/or the configuration hash module 223 can be stored at the memory 220 at a time of purchase of the mobile device 200. Alternatively, any of the software modules 221-222 and/or the configuration hash module 223 can be stored at the memory 220 in response to a download initiated by a user of the mobile device 200 (e.g., a download from an online marketplace such as an app store, a download performed in response to an instruction from an enterprise server to which the mobile device is connected, etc.).

The memory 220 can also alternatively store one or more resources (e.g., software resources such as drivers, code libraries, etc.) (not shown in FIG. 2) associated with the software modules 221-222 and/or the configuration hash module 223. In some embodiments, the memory 220 can further store device identifier (ID), software module identifier, hardware component ID and/or other information to be received and/or calculated by the configuration hash module 223.

The display 230 can be any display configured to display information to a user of the mobile device 200. For example, the display 230 can be a liquid crystal display (LCD), a light-emitting diode (LED) display, an organic light-emitting diode (OLED) display, a touchscreen, a tactile display, or other screen or display type. As shown in FIG. 2, the display 230 can receive information from the memory 220 and/or the processor 210. Although not shown in FIG. 2, in some embodiments the display 230 can receive information from the processor 210 and/or the memory 220 via one or more intermediary modules, such as one or more embedded hardware modules (e.g., a video hardware module). In some embodiments, the display 230 can display information associated with one or more of the software modules 221-222 and/or the configuration hash module 223.

The network card 240 can be a hardware module (e.g., a wired and/or wireless Ethernet card, a cellular network interface card) configured to transmit information (e.g., data packets, cells, etc.) from and receive information at the mobile device 200. As shown in FIG. 2, the network card 240 can be operatively and/or physically coupled to the processor 210. In this manner, the processor 210 can, via the network card 240, exchange information with one or more other devices via a network (e.g. the public network 120 discussed in connection with FIG. 1 above).

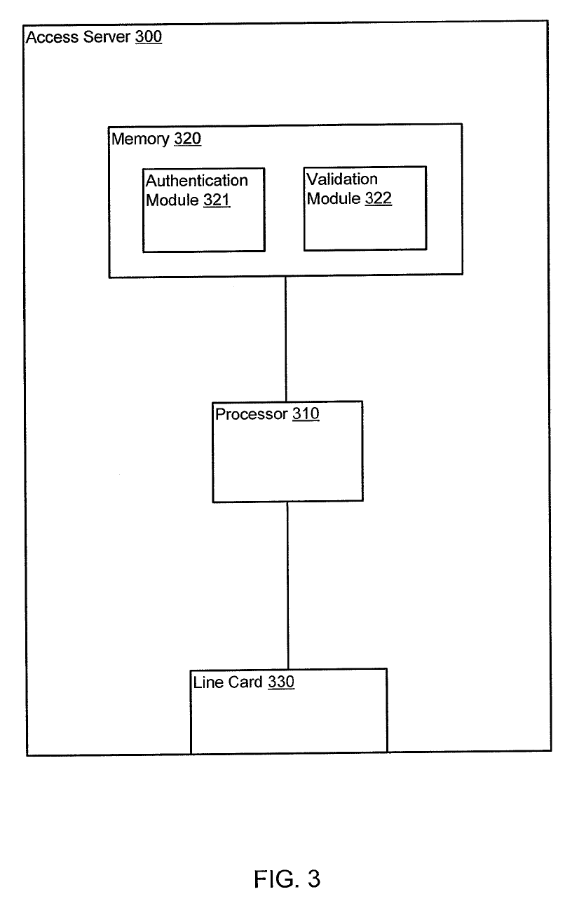

FIG. 3 is a schematic diagram that illustrates an access server storing an authentication module and a validation module, according to another embodiment. More specifically, FIG. 3 is a system block diagram of an access server 300, similar to the access server 130 described in connection with FIG. 1 above. The access server 300 includes a processor 310 operatively coupled to a memory 320 and to a network card 330. As shown in FIG. 3, the memory 320 includes an authentication module 321 and a validation module 322. In some embodiments, the access server 300 can include additional hardware modules and/or software modules (executing in hardware) not shown in FIG. 3. For example, the access server 300 can include one or more input devices and/or peripherals, one or more data input ports, etc.

The processor 310 can be any processor (e.g., a central processing unit (CPU), an application-specific integrated circuit (ASIC), or a field programmable gate array (FPGA)) configured to execute one or more instructions received from, for example, the memory 320. As shown in FIG. 3, the processor 310 can be in communication with any of the memory 320 and the network card 330. In some embodiments, the processor 310 can accordingly send information (e.g., data, instructions and/or network data packets) to and/or receive information from any of the memory 320 and the network card 330.

The memory 320 can be any memory (e.g., a RAM, a ROM, a hard disk drive, an optical drive, other removable media) configured to store information (e.g., a server operating system, a desktop operating system, one or software applications, etc.). As shown in FIG. 3, the memory 320 can include an authentication module 321 and a validation module 322. In some embodiments, the memory 320 can include instructions (e.g., code) sufficient to define and/or execute the authentication module 321 and the validation module 322. The memory 320 can also alternatively store one or more resources (e.g., software resources such as drivers, code libraries, etc.) associated with the authentication module 321 and/or the validation module 322. In some embodiments, the memory 320 can further store current and/or previous hardware, software and/or software permission information associated with the mobile device.

The authentication module 321 can optionally be a software module configured to determine whether a user of a mobile device is valid, i.e., whether the user should be allowed to access at least a portion of a private network to which the access server 300 is coupled. For example, the authentication module 321 can be configured to receive login and/or other credentials associated with a user of a mobile device. In some embodiments, the credentials can be included in a signal received at the access server via a public access network. In some embodiments, the credentials can be received from a mobile device requesting access to at least a portion of a private network to which the access server 300 is coupled. Upon receipt of the credentials, the authentication module 321 can determine whether the credentials are associated with a valid user. To do so, the authentication module 321 can optionally exchange one or more signals with another hardware and/or software module included in the access server 300. Alternatively, the authentication module 321 can exchange one or more signals with a separate device coupled to the private network. The separate device can be, for example, a database (e.g., private database 150 in FIG. 1) storing login credentials associated with one or more valid users registered to access the private network.

The validation module 322 can optionally be a software module configured to determine whether a requesting mobile device is valid, i.e., whether the mobile device has a valid hardware, software and/or software permissions configuration, and thus should be allowed to access at least a portion of a private network to which the access server 300 is coupled and/or in which the access server 300 is included. In some embodiments, the validation module 322 can receive, from a mobile device, a request to access a portion of the private network and/or a specified network resource (e.g., a protected resource). Alternatively, the validation module 322 can receive the request from another module included in the access server 300 (e.g., the authentication module 321). The access request can optionally include a device ID that uniquely identifies the mobile device and/or a configuration hash value associated with the mobile device.

If the access request includes a configuration hash value associated with the requesting mobile device, the validation module 322 can determine whether the received configuration hash value represents a valid mobile device configuration and/or is current. To do so, the validation module 322 can compare the received configuration hash value to a previously-stored valid configuration hash value associated with the device ID of that mobile device. The previously-stored valid configuration hash value can optionally be stored at a database included in the access server 300 and/or operationally coupled thereto. In such embodiments, if the validation module 322 determines that the received configuration hash value matches the previously-stored valid configuration hash value associated with the mobile device, the validation module 322 can determine that the mobile device is valid, and can accordingly send a response signal to the mobile device indicating that access to the private network and/or the protected resource has been granted.

If the received configuration hash value does not match the previously-stored valid configuration hash value, the validation module 322 can determine that a configuration of the requesting mobile device has changed since the previously-stored valid configuration hash value was calculated. As such, the validation module 322 can send, to the mobile device, a request for inventory and/or configuration information associated with the mobile device. For example, the validation module can request that the mobile device send, to the access server 300 (and thus the validation module 322), inventory and/or configuration information associated with the mobile device.

More specifically, hardware information included in the inventory and/or configuration information can include identification of one or more hardware components included in and/or coupled to the mobile device. The hardware information can include information sufficient to identify each such hardware module, such as unique hardware component identifiers (e.g., serial numbers). Alternatively or additionally, the hardware information can include hardware component type identifiers sufficient to indicate a type, make, model, or class of a given hardware component. The software information can include identification of one or more software modules (e.g., software programs, applications, packages, classes, etc.) stored at the mobile device. In some embodiments, the software information can include software identifiers, such as serial numbers, license keys, and/or other information sufficient to identify a given software module stored at the mobile device. In some embodiments, the software information can include software permission and/or feature information. For example, the software information can include one or more indications of one or more features included in, enabled by and/or associated with one or more of the identified software modules.

Upon receipt of the inventory information from the mobile device, the validation module 322 can determine whether the mobile device has a valid hardware, software and/or software permission configuration. To do so, the validation module 322 can, for example, compare each of the received hardware component identifiers to a predetermined list of prohibited (i.e., invalid) hardware components and/or a predetermined list of permitted (i.e., valid) hardware components. A predetermined list of prohibited hardware components can include, for example, a camera, an incompatible screen type or size, etc. In some embodiments, the predetermined lists can be stored at the memory 320, at another memory included in or operatively coupled to the access server 300, or at another memory operatively coupled thereto (e.g., a database included in the private network). If the validation module 322 determines that one or more of the hardware component identifiers is included in a list of prohibited hardware components, the validation module 322 can optionally determine that the mobile device has an invalid hardware configuration, and can accordingly send a signal to the mobile device indicating that access to the requested network resource has been denied. Alternatively, the validation module 322 can send a signal configured to (1) disable the prohibited hardware component, (2) notify the user that the prohibited hardware component has been disabled, and/or (3) indicate that access to the protected resource has been granted or denied.

The validation module 322 can next compare each received software module identifier to a predetermined list of prohibited software modules and/or a predetermined list of valid software modules. A predetermined list of prohibited software modules can include, for example, one or more malware, spyware, adware, virus, worm, or other potentially malicious software modules, programs, or applications. In some embodiments, the predetermined list of prohibited software modules can include one or more software modules incompatible with the private network and/or one or more protocols and/or operating systems employed thereby. If the validation module 322 determines that one or more of the software module identifiers is included in a predetermined list of prohibited software modules and/or identifiers, the validation module 322 can optionally determine that the mobile device has an invalid software configuration, and can accordingly send a signal to the mobile device indicating that access to the requested network resource has been denied. Alternatively, the validation module 322 can send a signal configured to (1) disable the prohibited software module, (2) notify the user that the prohibited software module has been disabled, and/or (3) indicate that access to the protected resource has been granted or denied.

The validation module 322 can next compare each received software permission/feature/capability to a predetermined list of prohibited software permissions and/or a predetermined list of valid software permissions. A predetermined list of prohibited software permissions or features can include, for example, a network-sniffing and/or recording feature, an encryption-cracking feature, etc. If the validation module 322 determines that one or more of the software module permissions is included in a predetermined list of prohibited software permissions, the validation module 322 can optionally determine that the mobile device has an invalid software permissions configuration, and can accordingly send a signal to the mobile device indicating that access to the requested network resource has been denied. Alternatively, the validation module 322 can send a signal configured to (1) disable the prohibited software permission(s) and/or feature(s), (2) notify the user that the prohibited software permission(s) and/or feature(s) has been disabled, and/or (3) indicate that access to the protected resource has been granted or denied.

In some embodiments, the validation module 322 can additionally determine whether any combination of an included hardware component, installed software module and/or software permission/feature present at the requesting mobile device is invalid. For example, the validation module 322 can determine that a combination of an operating system software module and an enabled web browser feature is invalid (due to, for example, potential security vulnerabilities associated therewith). In another example, the validation module 322 can determine that a combination of a given network-related hardware device and network-tracking software module is invalid (due to, for example, potential bandwidth management concerns associated therewith). In such embodiments, the validation module 322 can, upon determination that such an invalid combination is present at the mobile device, send a signal configured to notify the user that the access to the requested network resource has been denied. In some embodiments, the signal can be further configured to indicate to the user of the mobile device the reason for the denial of access and/or one or more suggestions for how the denial may be overcome and/or bypassed by the user.

In some embodiments, the above-described validation process can include granular access control configured to grant a requesting mobile device and/or user access to selected network resources included in the private network based at least in part on a role or access level associated with that mobile device and/or user. The role or access level can be determined, for example, based on one or more of: a previously-stored valid configuration hash value, a current hardware configuration of the mobile device, a current software configuration of the mobile device, a current software permissions configuration of the mobile device, another characteristic of the user, or any combination thereof.

The network card 330 can be a hardware module (e.g., a wired and/or wireless Ethernet card, a cellular network interface card) configured to transmit information (e.g., data packets, cells, etc.) from and receive information at the access server 300. As shown in FIG. 3, the network card 330 can be operatively and/or physically coupled to the processor 310. In this manner, the processor 310 can, via the network card 330, exchange information with one or more other devices (e.g., a mobile device similar to the mobile device 110 of FIG. 1) via a network (e.g., a network similar to the public wireless network 120 of FIG. 1).

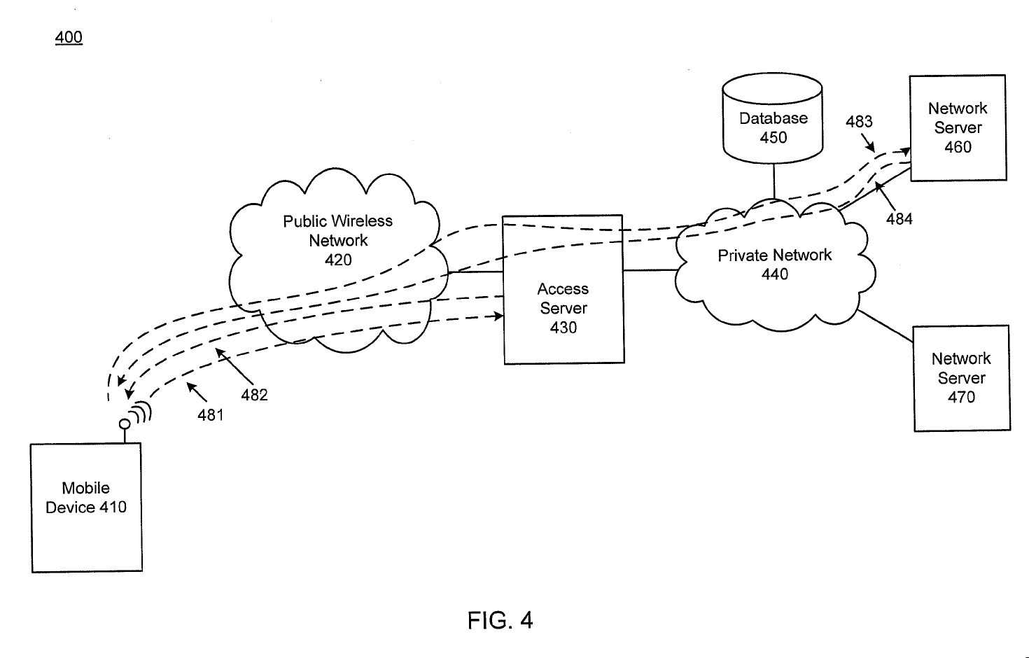

FIG. 4 is a schematic block diagram that illustrates a mobile device validation process performed at a hash-based device validation system, according to another embodiment. More specifically, FIG. 4 illustrates a mobile device 410 operatively (e.g., wirelessly) coupled to an access server 430 via a public wireless network 420. The access server 430 can be operatively and/or physically coupled to a private network 440, which can include and/or be coupled to a database 450, a network server 460 and a network server 470. Although not shown in FIG. 4, the private network 440 can include and/or be operatively coupled to multiple databases, network servers and/or other network devices, peripherals or resources.

The mobile device 410 can be any mobile computing device, such as a mobile/cellular telephone smartphone, tablet computing device, etc. In some embodiments, the mobile device 410 can be substantially similar to the mobile device 110 discussed in connection with FIG. 1 above, and/or to the mobile device 200 discussed in connection with FIG. 2 above. As shown in FIG. 4, the mobile computing device 410 can be operatively coupled and/or in communication with the access server 430 via the public wireless network 420. As further shown in FIG. 4, when granted access by the access server 430, the mobile device 410 can be in communication and/or can exchange data with one or more of the database 450, the network server 460 and the network server 470.

The public wireless network 420 can be any public cellular, Wi-Fi, WiMax or other wireless data network. In some embodiments, the public wireless network 420 can be substantially similar to the public wireless network 120 discussed in connection with FIG. 1 above.

The access server 430 can be any combination of hardware and/or software configured to regulate access of client devices (e.g., wireless devices such as the mobile device 410) to the private network 440. In some embodiments, the access server 430 can be a single server device, multiple server devices, a distributed service instantiated at multiple server devices, etc. In some embodiments, the access server 430 can be similar to the access server 130 discussed in connection with FIG. 1 above, and/or to the access server 300 discussed in connection with FIG. 3 above. As shown in FIG. 4, the access server 430 can optionally exchange signals and/or data with the mobile device 410 via the public wireless network 420.

The private network 440 can be any private LAN, WAN, intranet, extranet or other private computing network associated with one or more entities, organizations, and/or the like. In some embodiments, the private network 440 can be substantially similar to the private network 140 discussed in connection with FIG. 1 above.

The database 450 can be any database or database server included in and/or operatively and/or physically coupled to the private network 440. In some embodiments, the database 450 can be similar to the private database 150 described in connection with FIG. 1 above. The database 450 can optionally store information associated with one or more mobile devices and/or users, such as the mobile device 410 and/or a user thereof. For example, the database 450 can store a device ID of the mobile device 410, a configuration hash value associated with and/or based at least in part on a hardware configuration and/or software configuration of the mobile device 410, etc. In some embodiments, the database 450 can store one or more lists of allowed and/or prohibited hardware components, software modules, software permissions, and/or combinations thereof. In this manner, the database 450 can provide the access server 430 with information necessary to determine whether a mobile device is valid (and thus should be granted access to a requested resource included in the private network 440). The database 450 can also optionally store information associated with a user of a mobile device, such as authentication information of that user. The authentication information can include, for example, username, password, biometric credential, password question/answer and/or other user authentication information.

The network servers 460 and 470 can be any combination of hardware and/or software configured to provide the access server 430 and/or a mobile device (e.g., the mobile device 410) with data, services, functionality and/or other network resources or features. In some embodiments, the network servers 460 and 470 can be similar to the network servers 160 and 170 described in connection with FIG. 1 above. Although not shown in FIG. 4, in some embodiments, any or both of the network servers 460 and 470 can be included in a single physical device as one another and/or another resource or element of the private network 440 (e.g., the access server 430, the database 450).

As shown in FIG. 4, the mobile device 410 can send a signal 481 to the access server 430 via the private wireless network 420. The signal can optionally be sent wirelessly, e.g., via a wireless cellular data and/or computer network. Alternatively, the signal can be sent via one or more other means, e.g., a wired Ethernet or coaxial cable network, a Bluetooth connection, an Ultra Wide Band (UWB) connection, a wireless Universal Serial Bus (wireless USB) connection, an Intel Thunderbolt connection, and/or the like. The signal 481 can include, for example, a request to access one or more network resources stored and/or available at the network server 460. For example, the request can include a request to access a cloud-based application executing at the network server 460 (such as a cloud-based e-mail, productivity, multimedia, messaging, or other application).

In some embodiments, the signal 481 can include authentication credentials associated with a current user of the mobile device 410 and/or a configuration hash value associated with the mobile device 410. Alternatively, the signal 481 can include, in lieu of the configuration hash value, an indication from the mobile device 410 that a configuration hash value associated with the mobile device 410 has passed a device-executed, internal configuration hash value check, indicating that the hardware and/or software configuration of the mobile device 410 is consistent with a previously-calculated, valid configuration of the mobile device 410.

Upon receipt of the signal 481, the access server 430 can perform an authentication process associated with the user of the mobile device 410 and/or a validation process associated with the mobile device 410 itself. As described in connection with FIG. 3 above, the authentication process can include verification of one or more user credentials by accessing, for example, a database such as the database 450. The validation process can include, in some embodiments, comparison of a received configuration hash value to a previously-calculated, stored configuration hash value for the mobile device 410. Alternatively, the validation process can include a verification that the signal 481 includes an indication that the mobile device 410 has successfully performed an internal validation of the configuration hash value of the mobile device 410. If the access server 430 determines that verification of the configuration hash value has failed at the mobile device 410, it can optionally send a signal to the mobile device 410 requesting detailed hardware and/or software inventory information, as described in connection with FIG. 3 above (not shown in FIG. 4).

Having authenticated the user of the mobile device 410 and verified that the mobile device 410 has a valid inventory hash value (and thus a valid hardware and/or software configuration), the access server 430 can send a signal 482 to the mobile device 410 via the public wireless network 420. The signal 482 can include, for example, an indication that the user has been authenticated and/or that the mobile device 410 has been validated by the access server 430. Said differently, the signal 482 can include an indication that the mobile device 410 has been granted access to the requested network resource stored, executed and/or offered at the network server 460.

Upon receipt of the signal 482, the mobile device 410 can next send a signal to access the requested/desired network resource. More specifically, the mobile device 410 can send a signal 483 via the public wireless network 420 and the private network 440 to the network server 460. Although shown in FIG. 4 as passing through the access server 430, in some embodiments the signal 483 can be sent directly from the mobile device 410 to the network server 460 via one or more switching and/or routing elements of the private network 440 (not shown in FIG. 4).

When it receives the signal 483, the network server 460 can perform any appropriate operations and/or send any appropriate signals in response thereto. For example, if the signal 483 includes a request for new e-mail messages, the network server 460 can access one or more internal data stores and/or external data stores (e.g., the database 450) to determine any new e-mail messages associated with an indicated user account. Alternatively, if the signal 483 includes a request to save an indicated resource or file at a data store, the network server 460 can perform the operation using an internal/local and/or external data store included in or located outside the private network 440. Said differently, the network server 460 can, in response to the signal 483, provide functionality and/or data in response to one or more requests received from the mobile device 410.

As shown in FIG. 4, the network server 460 can send, to the mobile device 410, a signal in response to the signal 483. More specifically, the network server 460 can send the signal 484 to the mobile device 410 via the private network 440 and the public wireless network 420. The signal 484 can include, for example, requested e-mail messages responsive to the signal 483 and/or any other relevant data responsive to the signal 483. In this manner, the network server 460 can provide, to the mobile device 410, access to network services, functionality and/or data via a client-facing public network (e.g., the public wireless network 420).

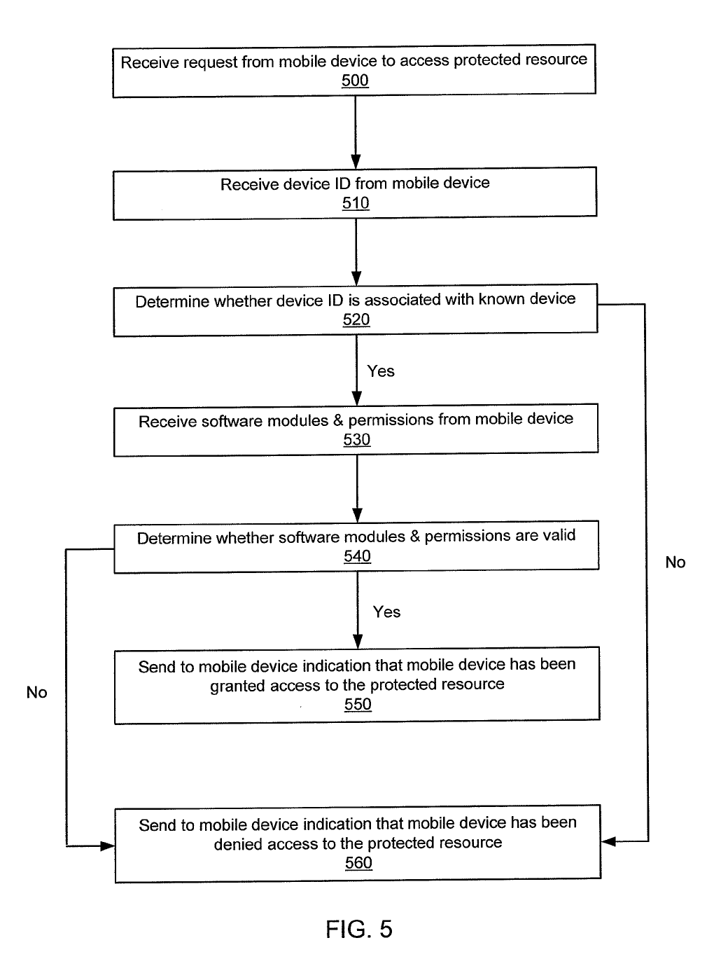

FIG. 5 is a flow chart describing a method of validating a mobile device for access to a protected resource, according to another embodiment. More specifically, FIG. 5 describes a method of validating that a mobile device requesting access to a protected resource included in a private network has a valid hardware and/or software configuration. By employing the method described in FIG. 5, a network device (e.g., an access server of a private network) can determine whether a requesting device should be granted access to a requested protected resource.

An access server can receive, from a mobile device, a request to access a protected resource, 500. The access server can be, for example, one or more hardware and/or software components and/or modules operatively and/or physically coupled to a private network (e.g., a company intranet, extranet, LAN, or WAN) and a public network (e.g., a public cellular or other wireless network owned and/or operated by a wireless data access provider). In some embodiments, the request can be included in a signal and can be formatted according to the Hypertext Transfer Protocol (HTTP) or other valid networking protocol.

The access server can receive a device ID from the mobile device, 510. In some embodiments, the device ID can be included in the initial resource request described in connection with step 500 above. Alternatively, the device ID can be included in a subsequent signal received from the mobile device in response to or independent of a signal sent from the access server requesting the device ID. The device ID can be any identifier sufficient to identify the requesting mobile device. For example, the device ID can be a seven-digit or ten-digit telephone number, or telephone number of another length. Alternatively, the device ID can be a unique identifier associated with the hardware components of the mobile device itself, such as a serial number unique to the mobile device.

The access server can determine whether the received device ID is associated with a known mobile device, 520. To do so, the access server can, for example, reference a database storing a list, table, or other record of device ID's associated with authorized and/or valid mobile devices. In this manner, the access server can determine that the requesting mobile device is a known and (potentially) trusted mobile device that has, optionally previously accessed one or more resources of the private network. For example, the access server can determine that the requesting mobile device is associated with a telephone number issued by an entity with which the private network is associated, that the requesting mobile device is associated with an employee or other member of the entity, etc.

If the access server determines that the device ID is not associated with a known mobile device, the access server can send, to the requesting mobile device, a signal indicating that the mobile device has been denied access to the protected resource, 560. Although not shown in FIG. 5, in some embodiments, the access server can alternatively proceed to perform a validation routine or process associated with the requesting mobile device, regardless of whether the requesting mobile device has a device ID recognized by and/or previously stored by the access server (or other data store included in the private network).

If the access server determines that the device ID is associated with a known mobile device, the access server can request and receive information describing the hardware components included in and/or software modules stored on the mobile device, 530. In this manner, the access server can receive, from the mobile device, configuration information sufficient to determine whether the mobile device has a valid hardware and/or software configuration. In some embodiments, the access server can receive the configuration information in one more signals sent by the mobile device. The one or more signals can include, for example, one or more data packets, cells, etc. including one or more records, lists, or other data identifying make, model, serial number, license key, and/or other identifier information associated with hardware components, software modules and/or software permissions/features/capabilities of the mobile device.

Upon receipt of the above-described configuration information, the access server (including, e.g., a validation module similar to the validation module 322 described in connection with FIG. 3 above) can determine whether the mobile device has a valid hardware and/or software configuration, 540. More specifically, the access server can compare hardware component identifier information with one or more lists and/or records indicating allowed/valid and/or prohibited/invalid hardware component identifiers, serial numbers, types, classes, makes, models, etc. The access server can also compare any received software module information with one or more lists and/or records indicating allowed/valid and/or prohibited/invalid software modules (as identified, for example, by license keys, serial numbers, application name, application provider/developer, etc.). The access server can also compare any received software feature/permission/capability information with one or more lists and/or records indicating allowed/valid and/or prohibited/invalid software features. The access server can further compare any of the above-described configuration information with or against any predefined invalid hardware, software and/or software feature combinations. In this manner, the access server can determine whether each hardware component, software module, software feature/permission and/or combination thereof is valid.

In some embodiments, the access server can reference the above-described lists and/or records via a separate device included in or external to the private network. Alternatively, the access server can forward the received configuration information to a separate device for validation at that separate device.

If the access server determines that any of the above-described configuration information indicates an invalid/unauthorized component, module, permission, or other configuration or setting, the access server can send, to the mobile device, an indication that the mobile device has been denied access to the protected resource, 560.

Alternatively, if the access server (1) determines that each hardware component, software module, software feature/permission and/or combination thereof at the mobile device is present in a list or record of valid/authorized mobile device elements, and/or (2) that none of the above-described elements is present in a list or record of invalid/unauthorized mobile device elements, the access server can determine that the mobile device has a valid configuration. As such, the access server can send, to the mobile device, a signal including an indication that the mobile device has been granted access to the protected resource, 550. In some embodiments, the access server can calculate and store an updated, current configuration hash value for the mobile device based at least in part on the received configuration information. In this manner, the access server can store a configuration hash value for future use in validating the mobile device. In some embodiments, the access server can send a signal including the updated hash value to the mobile device for local storage and use (e.g., for subsequent use in determining, at the mobile device, whether a configuration of the mobile device has changed since the current inventory validation process (“integrity check”)). Although not described in FIG. 5, upon sending this signal, the access server can send additional signals to the mobile device to facilitate and/or provide access to the protected resource.

FIG. 6 is a diagram that illustrates a method of calculating a device configuration hash value, according to another embodiment. More specifically, FIG. 6 illustrates a calculation that can be performed by a mobile device and/or an access server of a private network to determine a single hash value representing a hardware, software and/or software permission configuration of the mobile device. Based at least in part on this single hash value, a device (e.g., the mobile device and/or the access server) can determine whether a current configuration of the mobile device has changed since a previous calculation of the hash value. In this manner, a device can determine whether a more-thorough evaluation of the current configuration of the mobile device (e.g., an “integrity check”) is necessary to determine the validity of that mobile device (and thus that mobile device's eligibility to access a secured network).

As shown in FIG. 6, the hash value calculation can include a device ID. The device ID can be, for example, an identifier (e.g., a unique identifier) associated with the mobile device. As described in connection with FIGS. 3-5 above, the device ID can be a device serial number, telephone number associated with the mobile device, a unique identifier of a network card or other hardware component of the mobile device, etc.

The configuration hash value calculation can also include one or more hardware component identifiers (IDs) (e.g., the hardware component ID₁, the hardware component ID₂ and the hardware component ID₃), each identifying a hardware component of the mobile device. One or more of the hardware component IDs can be, for example, a hardware component serial number, model identifier, and/or the like. In some embodiments, one or more of the hardware component IDs can be included in the configuration hash value calculation along with a weight or other coefficient value. In some embodiments, one or more of the hardware component IDs can be included only in part and/or can be shortened, truncated and/or otherwise transformed prior to being included in the calculation.

As further shown in FIG. 6, the configuration hash value calculation can additionally include one or more software module identifiers (IDs) (e.g., the software module ID₁, the software module ID₂ and the software module ID₃), each identifying a software module stored at a memory of and/or executing at a processor of the mobile device. One or more of the software module IDs can be similar to the software module IDs described in connection with FIGS. 3-5 above, and can be included in the configuration hash value calculation along with a weight or other coefficient value. As with the hardware component IDs, each or any of the one or more software module IDs can be shortened, truncated and/or otherwise transformed prior to being included in the calculation.

The configuration hash value calculation can additionally include one or more indicators or identifiers of one or more permissions, features, capabilities, options and/or settings of the one or more software modules described above. As shown in FIG. 6, the configuration hash value calculation includes a software module permission₁, a software module permission and a software module permission₃. As further illustrated in FIG. 6, the software module permissions can be combined with (e.g., added to, lexicographically combined with, concatenated to, etc.) the device ID, the one or more hardware component IDs and the one or more software module IDs to calculate a single hash value representing the inventory (i.e., the hardware and software configuration) of the mobile device.

As described in connection with FIGS. 3-5 above, the configuration hash value can be used to, for example, determine whether the inventory/configuration of the mobile device has changed from one time period to another. More specifically, the configuration hash value can compared (by, e.g., an access server) to a previously-calculated configuration hash value for the mobile device. If the configuration hash value is different from the previously-calculated configuration hash value, the device performing the comparison can determine that one or more settings, hardware components, software modules, software permissions, etc. of the mobile device has changed since the previous configuration hash value calculation was performed. Based at least in part on this determination, the device (e.g., the access server) can determine that a partial or complete inventory evaluation/integrity check of the mobile device should be performed.

Some embodiments described herein relate to a computer storage product with a computer-readable medium (also can be referred to as a processor-readable medium) having instructions or computer code thereon for performing various computer-implemented operations. The media and computer code (also can be referred to as code) may be those designed and constructed for the specific purpose or purposes. Examples of computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), and read-only memory (ROM) and RAM devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

While various embodiments have been described above, it should be understood that they have been presented by way of example only, not limitation, and various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described. For example, a mobile device validation system can include multiple access servers configured to authenticate one or more mobile device users and/or to validate one or more client mobile devices.

What is claimed is:

1. A non-transitory processor-readable medium storing code representing instructions configured to cause a processor to:
receive, from a mobile device, a first signal including a hash value based at least in part on (1) a set of unique hardware identifiers, each unique hardware identifier from the set of unique hardware identifiers being associated with a hardware component from a set of hardware components of the mobile device, and (2) a set of software identifiers uniquely associated with a set of software modules stored at the mobile device; and
send, to the mobile device, a second signal when the hash value matches a predetermined hash value associated with the mobile device, the second signal configured to grant the mobile device access to a network.

2. The non-transitory processor-readable medium of claim 1, wherein the hash value is further based at least in part on (3) a set of permissions uniquely associated with the set of software modules.

3. The non-transitory processor-readable medium of claim 1, wherein the second signal is sent when the set of software modules stored at the mobile device does not include a predetermined software module.

4. The non-transitory processor-readable medium of claim 1, wherein the hash value is a first hash value, the predetermined hash value is a first predetermined hash value, the first signal is received at a first time, and
the code further represents instructions configured to cause the processor to:
receive from the mobile device, at a second time after the first time, a third signal including a second hash value different from the first hash value, the second hash value being based on a configuration of the mobile device at the second time,
send, to the mobile device, a fourth signal when the second hash value matches a second predetermined hash value associated with the mobile device, the fourth signal configured to grant access to the network, and
send, to the mobile device, a fifth signal when the second hash value does not match the predetermined stored hash value, the fifth signal configured to indicate that the mobile device has not been granted access to the network.

5. The non-transitory processor-readable medium of claim 1, wherein the code further represents instructions configured to cause the processor to:
send, to the mobile device, a third signal when the hash value does not match the predetermined hash value, the third signal configured to indicate that the mobile device has not been granted access to the network.

6. The non-transitory processor-readable medium of claim 1, wherein the code further represents instructions configured to cause the processor to:
determine that the hash value does not match the predetermined hash value;
determine whether a first software module is included in the set of software modules stored at the mobile device;
determine whether a first permission is included in a set of permissions uniquely associated with the set of software modules; and
send, to the mobile device, a third signal configured to grant access to the network when the first software module is not included in the set of software modules stored at the mobile device and the first permission is included in the set of permissions.

7. The non-transitory processor-readable medium of claim 1, wherein at least one unique identifier from the set of unique identifiers is a hardware component serial number.

8. A method, comprising:
receiving, from a device, a first signal including a request to access a protected resource;
receiving, from the device, a second signal including a device identifier (ID) value associated with the device, the device ID value being based at least in part on a unique device identifier;
determining, based on the device ID value, that the device is an authorized device; receiving, from the device, a third signal including (1) a set of software module identifiers associated with a set of software modules stored at the device and (2) a set of permissions associated with the set of software modules;
determining, based on the third signal, (1) whether the set of software modules is valid and (2) whether the set of permissions associated with the set of software modules is valid; and
when the set of software modules is valid and the set of permissions associated with the set of software modules is valid, sending, to the device, a fourth signal configured to grant access to the protected resource.

9. The method of claim 8 wherein the protected resource is a first protected resource, further comprising:
receiving, from the device, a fourth signal including a set of hardware component identifiers associated with the device;
determining, based on the set of hardware component identifiers, that the device does not include an authorized hardware configuration; and
sending, to the device, a fifth signal indicating that access to a second protected resource has been denied.

10. The method of claim 8, wherein the determining whether the set of software modules is valid includes:
determining whether any combination of any permission from the set of permissions and any software module identifier from the set of software module identifiers is invalid.

11. The method of claim 8, wherein the protected resource is a first protected resource, further comprising:
when the set of software modules is invalid, sending, to the device, a fifth signal indicating that access to the protected resource has been denied; and
when the set of permissions associated with the set of software modules is invalid, sending, to the device, a sixth signal indicating that access to the protected resource has been denied.

12. The method of claim 8, further comprising:
sending, to the device, a fifth signal configured to disable a specified software module from the set of software modules, the fourth signal being sent prior to the fourth signal.

13. The method of claim 8, wherein the fourth signal is sent when the device has passed at least one of a biometric authentication process, a geolocation authentication process, or a password authentication process.

14. A non-transitory processor-readable medium storing code representing instructions configured to cause a processor to:
calculate a hash value associated with a mobile device, the hash value based at least in part on at least one of: a device identifier (ID) of the mobile device, a set of hardware components included in the device, or a set of software modules stored at the mobile device; and
when the hash value does not match a stored hash value associated with the mobile device:
send, to a server, a first signal including (1) an indication of the device ID, (2) an indication of at least one hardware component from the set of hardware components; and (3) an indication of at least one software module from the set of software modules; and
receive, from the server, in response to the third signal, a second signal configured to grant access to a network resource.

15. The non-transitory processor-readable medium of claim 14, wherein the set of hardware components includes at least one external hardware module operatively coupled to the mobile device.

16. The non-transitory processor-readable medium of claim 14, wherein the set of software modules is a set of software modules stored at the mobile device at a first time, and the set of software modules includes a mobile device application installed after a second time and before the first time.

17. The non-transitory processor-readable medium of claim 14, wherein the code further represents instructions configured to cause the processor to:
encrypt the first signal using an encryption key associated with the mobile device.

18. The non-transitory processor-readable medium of claim 14, wherein the code further represents instructions configured to cause the processor to:
send, prior to the first signal, a third signal including authentication credentials associated with a user of the mobile device, the authentication credentials including at least one of a username, a password, a security question response, or a biometric identifier.

19. The non-transitory processor-readable medium of claim 14, wherein the second signal includes at least one permission setting based at least in part on at least one of (1) the indication of the device ID, (2) the indication of at least one hardware component from the set of hardware components, and (3) the indication of at least one software module from the set of software modules.

20. The non-transitory processor-readable medium of claim 14, wherein the code representing instructions configured to cause the processor to calculate is configured to be executed in response to the mobile device being powered on.
